(19) United States
(12) Patent Application Publication
(10) Pub. No.: US 2014/0114796 A1
(43) Pub. Date: Apr. 24, 2014

(54) TECHNIQUES FOR GENERATING CONTENT RECOMMENDATIONS

(71) Applicant: BarnesandNoble.com, LLC, (US)

(72) Inventors: Jonathan Huizhong Huang, Cupertino, CA (US); Yufan Hu, North Brunswick, NJ (US)

(73) Assignee: barnesandnoble.com llc, New York, NY (US)

(21) Appl. No.: 13/656,117

(22) Filed: Oct. 19, 2012

(51) Int. Cl. G06Q 30/06

(52) U.S. Cl. CPC G06Q 30/0631
USPC 705/26.7

(57) ABSTRACT

Techniques are disclosed for providing product recommendations based on content clusters. The product may be, for example, goods or services. In some embodiments, the techniques include forming a product cluster based at least in part on product metadata, correlating the product cluster based at least in part on product correlation data, and calculating each product distance to a center of each correlated product cluster. In some cases, the techniques may further include generating recommendations based on product clusters, wherein only products within a given distance to a center of each correlated product cluster are recommended. In some cases, forming a product cluster is carried out using k-means clustering so as to minimize the within-cluster sum of squares, and the techniques may further include optimizing the within cluster sum of squares.

### RELATED APPLICATION

This application is related to U.S. application Ser. No. ______ (Attorney Docket BN01.720US) filed Oct. 19, 2012 and titled “System for Generating Content Recommendations” which is herein incorporated by reference in its entirety.

### FIELD OF THE DISCLOSURE

The invention relates to generating content recommendations to users, and more particularly, to generating content recommendations to users based at least in part on attributes.

### BACKGROUND

Presently, there are a variety of methods for generating recommendations for products or services to users. Typically, the methods rely on data in a system based on a certain content provider. For example, one user recommendation may result from a single source provider that indicates various services and products offered by that provider. Likewise, the user recommendation could also be with respect to service and/or products that are related, wherein the recommendation effectively suggests services and products that are related to another specific service or product. In other examples, users may simply limit their search or analysis for products and services that are related to previous purchases or searches. Making effective recommendations involves a number of non-trivial issues.

### SUMMARY

One embodiment of the present invention provides a method for generating content recommendations. The method includes forming a product cluster based at least in part on product metadata, correlating the product cluster based at least in part on product correlation data, and calculating each product distance to a center of each correlated product cluster. In some cases, the product metadata comprises data from one or more book publishers and/or online book sellers, including at least one of book genre-based taxonomy, demographics of user, and/or previous purchase information associated with that user. In one such case, the product metadata further comprises time of year. In some cases, the product correlation data comprises product co-purchase correlation data that reflects related products previously purchased or considered by a given user. In some cases, the product correlation data comprises product correlation data that reflects related products contemporaneously considered by a given user within a single transaction. In some cases, forming the product cluster is initiated in response to a user request. In some cases, the method further includes displaying recommendations to a given user based on product clusters, wherein only products within a given distance to a center of each correlated product cluster are displayed. In some cases, the method further includes generating recommendations based on product clusters, wherein only products within a given distance to a center of each correlated product cluster are recommended. In some cases, forming a product cluster is carried out using k-means clustering so as to minimize the within-cluster sum of squares, the method further comprising optimizing the within cluster sum of squares. In some cases, the method further includes generating an output based on product clusters, the output including related taxonomy and product recommendations. In some cases, forming a product cluster is further based on a set of products (e.g., diverse collection of books or eBooks).

Another embodiment of the present invention provides a computer readable medium encoded with instructions that when executed by one or more processors cause a process for generating content recommendations to be carried out. The process includes forming a product cluster based at least in part on product metadata, correlating the product cluster based at least in part on product correlation data, and calculating each product distance to a center of each correlated product cluster. In some cases, the product metadata comprises data from one or more book publishers and/or online book sellers, including at least one of book genre-based taxonomy, demographics of user, previous purchase information associated with that user, and/or time of year. In some cases, the product correlation data comprises at least one of product co-purchase correlation data that reflects related products previously purchased or considered by a given user and/or product correlation data that reflects related products contemporaneously considered by a given user within a single transaction. In some cases, forming the product cluster is initiated in response to a user request. In some cases, the process further includes displaying recommendations to a given user based on product clusters, wherein only products within a given distance to a center of each correlated product cluster are displayed. In some cases, the process further includes generating recommendations based on product clusters, wherein only products within a given distance to a center of each correlated product cluster are recommended. In some cases, forming a product cluster is carried out using k-means clustering so as to minimize the within-cluster sum of squares, the method further comprising optimizing the within cluster sum of squares. In some cases, the process further includes generating an output based on product clusters, the output including related taxonomy and product recommendations.

Another embodiment of the present invention provides a computer readable medium encoded with instructions that when executed by one or more processors cause a process for generating content recommendations to be carried out. The process includes forming a product cluster based at least in part on a set of products and product metadata, wherein the product metadata comprises data from one or more book publishers and/or online book sellers, including at least one of book genre-based taxonomy, demographics of user, previous purchase information associated with that user, and/or time of year. The process further includes correlating the product cluster based at least in part on product correlation data, wherein the product correlation data comprises product co-purchase correlation data that reflects related products previously purchased or considered by a given user. The process further includes calculating each product distance to a center of each correlated product cluster, and generating recommendations based on product clusters, wherein only products within a given distance to a center of each correlated product cluster are recommended.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 illustrates a method for generating user recommendations in accordance with an embodiment of the present invention.

FIG. 2 depicts a hierarchy tree showing a number of product categories and corresponding products, in accordance with an embodiment of the present invention.

FIG. 3 depicts an example output of product recommendations in the form of displayed content cluster results, in accordance with an embodiment of the present invention.

FIG. 4 illustrates a system for generating user recommendations in accordance with an embodiment of the present invention.

FIG. 5 illustrates an example server that can be used in the system of FIG. 4 in accordance with an embodiment of the present invention.

### DETAILED DESCRIPTION

Techniques are disclosed for generating content recommendations. In some embodiments, the techniques include forming a product cluster based at least in part on product metadata, correlating the product cluster based at least in part on product correlation data, and calculating each product distance to a center of each correlated product cluster. In some cases, the techniques may further include generating recommendations based on product clusters, wherein only products within a given distance to a center of each correlated product cluster are recommended. In some cases, forming a product cluster is carried out using k-means clustering so as to minimize the within-cluster sum of squares, and the techniques may further include optimizing the within cluster sum of squares.

General Overview

As previously explained, making effective recommendations to a user involves a number of non-trivial issues. For instance, typical methods for making recommendations for products and services tend to be limited in scope and fail to incorporate an intelligent and correlated recommendation based on pertinent factors and attributes not effectively considered.

Thus, and in accordance with various embodiments of the present invention, techniques are disclosed for generating content recommendations to users based at least in part on attributes. In one such embodiment, the techniques include generating content clusters (e.g., product clusters and/or service clusters) that can be recommended to a user. In one specific such case, generating the recommendable clusters includes forming a product (or content) cluster based at least in part on product/content metadata, correlating the cluster based at least in part on product correlation data, and calculating each product distance to a center of each cluster. In some such example cases, calculating each product distance to a center of each cluster includes optimizing the within cluster sum of squares (WCSS).

The techniques can be implemented, for instance, in a system for generating content clusters, wherein the techniques are implemented with software, hardware, firmware, or some combination thereof. The system may be, for example, an online product ordering system, where the product is books including hardcover books, softcover books, and/or electronic books (or so-called eBooks), covering a virtually unlimited array of topics that may be of interest to users. However, the system can be used with any type of product(s) and need not be Internet-based, as will be appreciated in light of this disclosure. Another example embodiment, for example, may include a counter-based system that is locally installed and limited to products within a given brick-and-mortar store, such as a Wal-Mart or any other store that has a vast catalog/inventory of diverse products or one or more product lines each having a vast amount of diverse content within that product line. Numerous variations and embodiments will be apparent in light of this disclosure.

In one example case, the system includes a server that is programmed or otherwise configured to carryout content clustering based at least in part on attributes such as a user's preferences, purchases, viewings and readings of content over a duration of time. In addition, various internal and external structured and/or unstructured data and taxonomies may be utilized to identify applicable recommendations, in accordance with some embodiments. As will be appreciated, the cluster formation process may be a metadata driven cluster formation and correlation driven cluster formation, in accordance with an embodiment.

Methodology

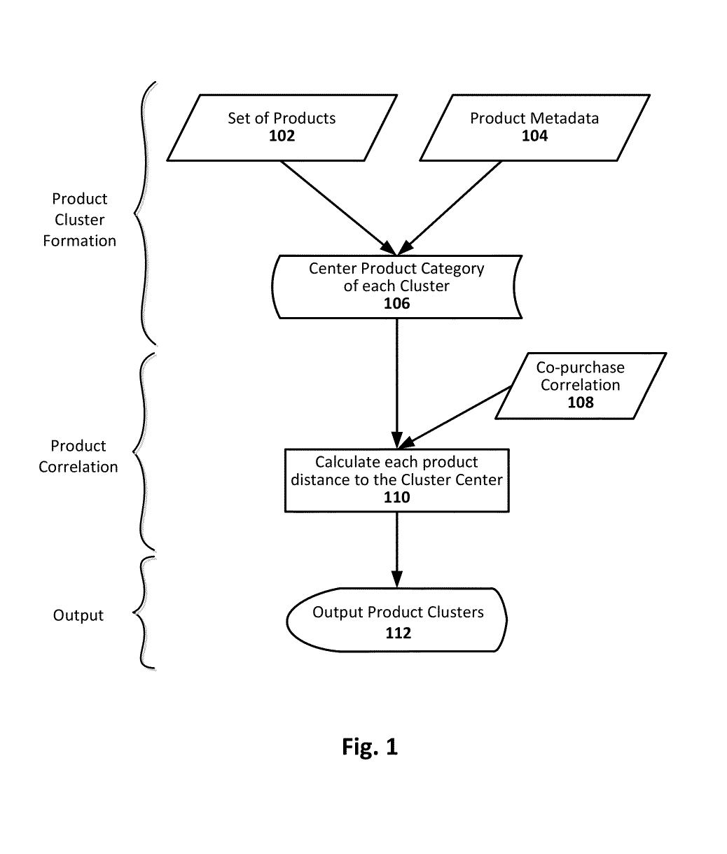

FIG. 1 depicts a method of a flowchart based on an embodiment of the claimed subject matter for generating user recommendations. As can be seen, the method includes a product cluster formation stage (or content cluster formation stage), a correlation stage, and an output stage.

With further reference to FIG. 1, block 102 defines a set of products to be used as a first input to block 106 to eventually generate a centering of product category of each cluster. Likewise, a second block 104 that contains product metadata from book publishers, e-commerce sites, or databases is used as a second input to block 106 to eventually generate a centering of product category of each cluster. Examples of metadata that can be used include, for instance, a taxonomy from book publishers on genre (e.g., history, romance, business, etc.), purchaser demographics (e.g., location, zip code, apartment, house), previous purchase information, and time of year. Other such useful metadata will be apparent in light of this disclosure.

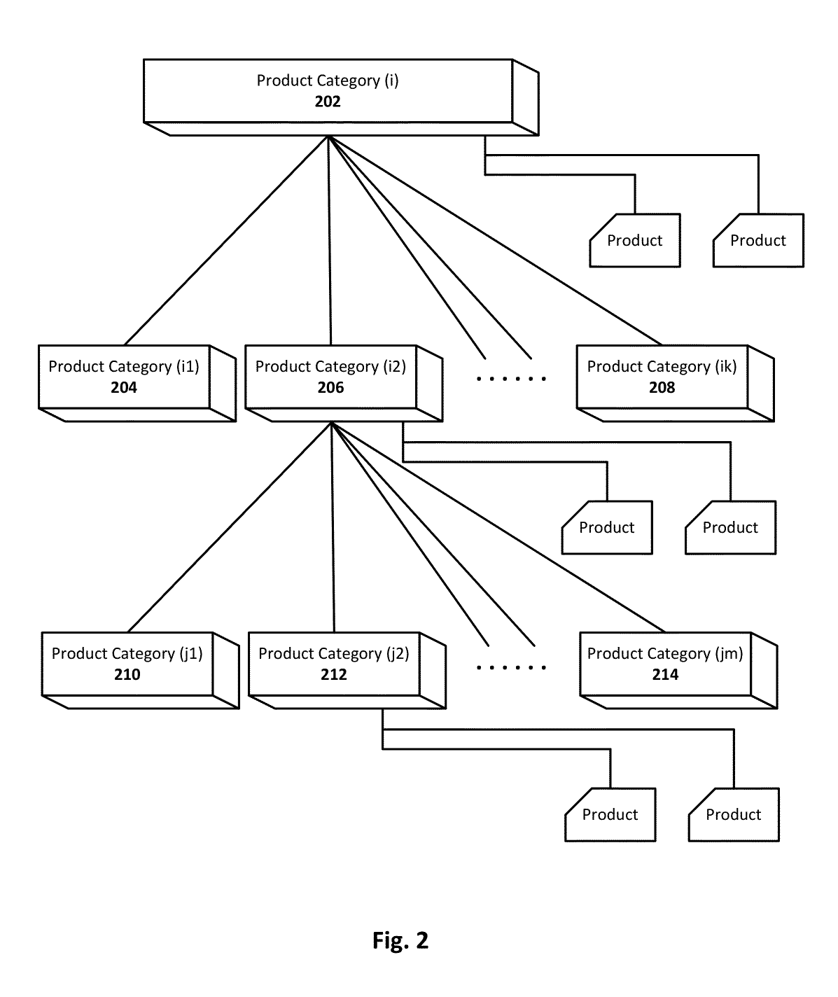

The various blocks 102, 104, and 106 and how the metadata is used to drive the cluster formation will be further discussed in turn and with reference to FIG. 2. Subsequently, the output of block 106 is used as a first input to block 110, which depicts calculating each product distance to the cluster center. Likewise, a second block 108 that contains product co-purchase correlation data is used as a second input to block 110. Product correlation as used herein generally refers to a product being purchased (or otherwise considered for purchase) that is related to another purchase or item of interest to the user. For example, a bookseller may know that a given consumer bought a particular book and at the same time also bought a movie-version (e.g., DVD) of that book. A product co-purchase correlation refers to the same thing but the product purchases happened at different times (e.g., two different checkouts on same day or on different days, etc).

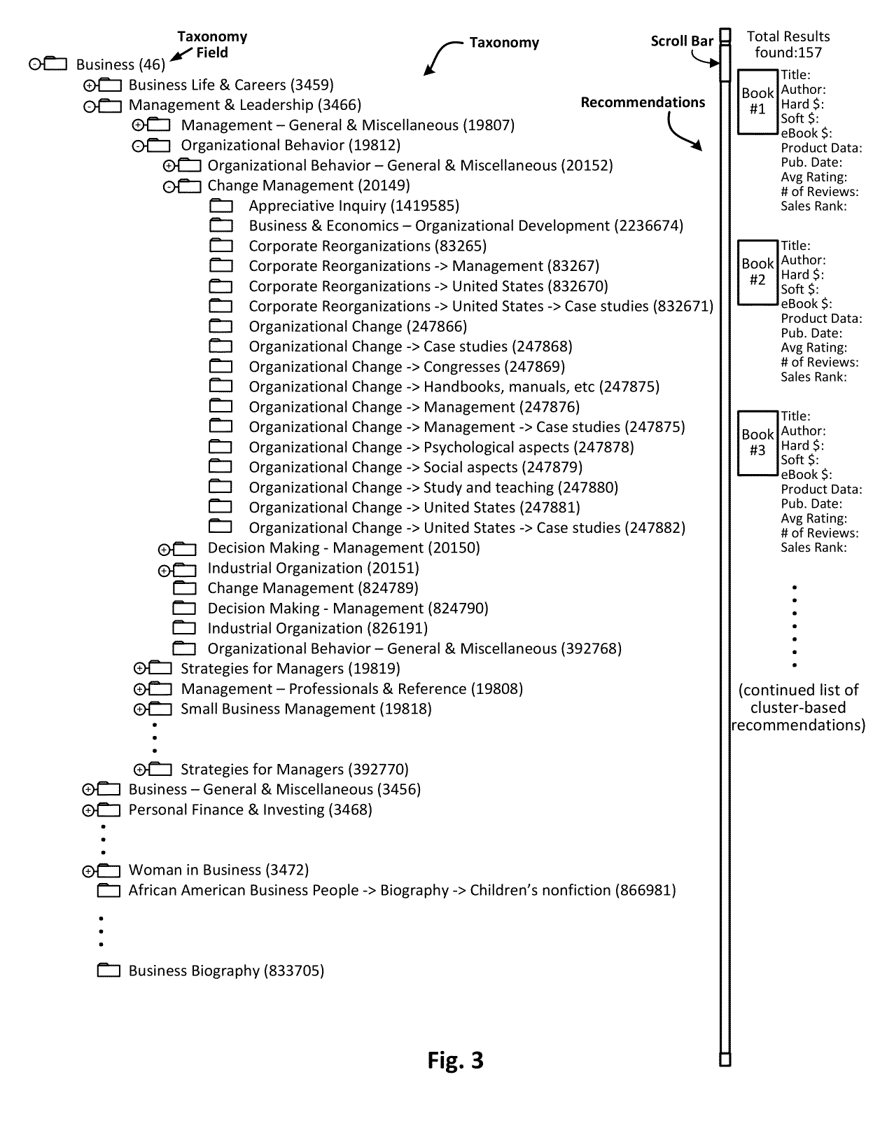

Once the product cluster is formed (102, 104, 106) and optimized (108, 110), the method may further continue at block 112, which depicts the output of product clusters. The output can be presented to the user, for example, in the form of a graphical user interface that allows the user to scroll through or otherwise view the recommendation results. One such example embodiment is shown in FIG. 3, which will be discussed in turn.

Thus, an embodiment of the present invention utilizes a metadata driven cluster formation process to generate a center product category of each cluster at 106. In more detail, and with reference to FIG. 2, assume a set of product categories, say PC={PC1, PC2, PC3, PCn, P}, where PCi is a product category and products P={P1, P2, P3, . . . , Pm}. Each product belongs to one or more product categories, and each category contains products and subcategories. For each element PC(i), in set PC (depicted as block 202), it contains a number of children product categories PC(i1), PC(i2), . . . , PC(ik) (depicted as 204, 206, and 208) and some products, as shown below. In one embodiment, if PC(i) is not a child of any elements in PC, it can be denoted as a root of the hierarchy tree PR(i), and define the product category as a cluster. Likewise, this is repeated again for product category PC(i2) (depicted at 206), which contains a number of children product categories PC(j1), PC(j2), . . . , PC(jm) (depicted as 210, 212, and 214) and some products, as shown below. Consequently, the product categories can be defined as clusters based at least in part on the metadata and children product categories, in accordance with some embodiments.

Next, in one embodiment for a centroid-based clustering, clusters are represented by data sets, or collections of product category roots (PR1, PR2, PR3, . . . , PRn), and k-means clustering is used to partition the n observations into k sets (k≦n) S={S1, S2, . . . , Sk}, so as to minimize the within-cluster sum of squares (WCSS): argMin Σᵢ₌₁^{k}Σ_{PCjεPRi}∥PCⱼ−μi∥², where μi is the mean of points in Si. In one embodiment for heuristic mean of points, the example defines k=n so that each set is a partition, or a collection of product category. Thus, μᵢ is the mean of point in PRi, that is pre-determined by the metadata driven cluster formation, being the most massive product category PCi in PRi. In one specific example embodiment, the definition of a product category mass can be sale volume, popularity, or other measures such as views, likes, ratings, etc. Consequently, mean points are calculated. Subsequently, an embodiment of the present invention substitutes the within-cluster sum of squares with distance from PCi. The definition of distance between two Product Categories is reversed proportional to co-purchase correlation.

As previously explained, the methodology can be implemented in software, such as a set of instructions (e.g. C, C++, object-oriented C, JavaScript, BASIC, etc) encoded on a server (or any other computer readable medium), that when executed, cause the method to be carried out. In other embodiments, the method may be implemented with hardware, such as gate level logic (e.g., FPGA) or a purpose-built semiconductor (e.g., ASIC). Still other embodiments may be implemented with a microcontroller having a number of input/output ports for receiving and outputting data, and a number embedded routines for carrying out the functionality described herein. Any suitable combination of hardware, software, and firmware can be used.

FIG. 3 depicts an output example from block 112 in FIG. 1, in accordance with one embodiment. In this example case, several books are depicted that list relevant data and attributes that show content clusters with the actual results displayed. As can be seen, the related taxonomy is shown on the left and the resulting recommendations on the right. The resulting recommendations included in this example content cluster are depicted as including an icon of a book that may be of interest to the user, along with other relevant data such as the title, author, hardcover cost, soft cover cost, eBook cost, product data (e.g., inventory number, record number, index, related search engine tag or attribute or other indicia, etc). Other relevant data depicted in this example embodiment includes the publication date, average rating and number of reviews, and sales rank. As will be appreciated, the displayed data will vary depending on factors such as the product of interest.

As will be appreciated in light of this disclosure, attributes and metadata as used herein are generally interchangeable, but in different context. Metadata is used, for example, in the context of an Internet-based architecture and data transfer, while attribute is more generic. To this end, metadata can be thought of as the stored version of data used in e-commerce to define attributes of a given e-commerce sale, in accordance with some embodiments.

System Architecture

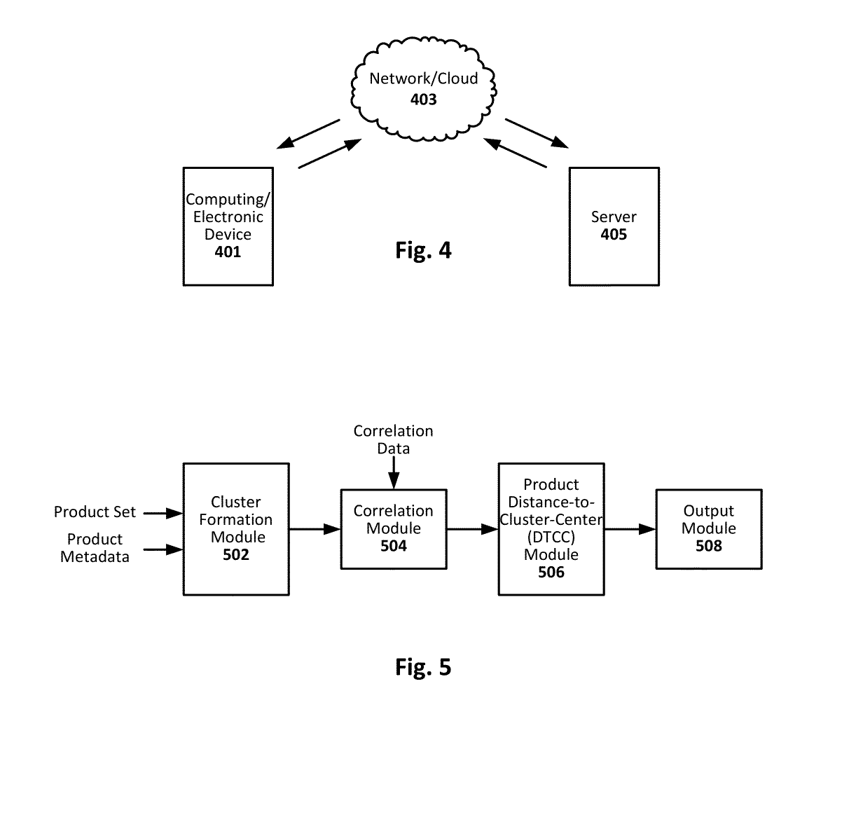

FIG. 4 illustrates a system for generating user recommendations in accordance with an embodiment of the present invention. As can be seen, the system generally includes an electronic device 401 that is capable of communicating with a server 405 via a network/cloud 403. In this example embodiment, the electronic device 402 may be, for example, an eBook reader, a mobile cell phone, a laptop, a tablet, desktop, or any other computing device. The network/cloud 403 may be a public and/or private network, such as a private local area network operatively coupled to a wide area network such as the Internet. In this example embodiment, the server 405 is programmed or otherwise configured to receive content recommendation requests from a user via the device 401 and to respond to those requests by providing the user with recommendations in the form of content clusters computed as described herein. Is some such embodiments, software on the server is executed on the fly that analyzes and incorporates the methodologies provided herein. In other embodiments, portions of the methodology are executed on the server 405 and other portions of the methodology are executed on the device 401. Numerous server-side/client-side execution schemes can be implemented, as will be apparent in light of this disclosure.

FIG. 5 illustrates an example server that can be used in the system of FIG. 4 in accordance with an embodiment of the present invention. As can be seen, the server includes a cluster formation module 502, a correlation module 504, a product distance-to-cluster-center (DTCC) module 506, and an output module 508. As will be appreciated in light of this disclosure, these modules need not be limited to a server application, but can also be implemented in numerous other applications such as a stand-alone system, and may be implemented in hardware, software, firmware or any combination thereof as previously explained.

The cluster formation module 502 is programmed or otherwise configured to receive a product set and product metadata, and to form a product cluster based at least in part on the metadata associated with that product. While the content being recommended in this example case is a product offered by a seller (such as books as previously explained), other embodiments may recommend content in the form of services offered by a seller. Likewise, the content may be in the form of a combination of products and services offered by a seller. As will be further appreciated, note that the seller may actually be multiple sellers.

The correlation module 504 is programmed or otherwise configured to correlate the product cluster based at least in part on correlation data. As previously explained, the correlation data may include, for instance, data with respect to one or more products purchased (or considered for purchase) that are related to another purchase or item of interest to the user (whether previously expressed by the user, or contemporaneously expressed with the current user request). The product distance-to-cluster-center (DTCC) module 506 is programmed or otherwise configured to optimize the within cluster sum of squares effectively generated by the cluster formation module 502, using the correlated product cluster.

The output module 508 is programmed or otherwise configured to provide the recommended products clusters to the user using, for example, a graphical user interface or other suitable display mechanism. In some embodiments, the output module 508 may be configured to provide an aural presentation of the recommended products clusters, so that no display is needed. Still in other embodiments, the output module 508 may be configured to provide a printable output data file of the recommended products clusters, so the user can create a hard copy of the results if so desired. Numerous output formats and schemes can be used.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed:

1. A method for generating content recommendations, comprising:
forming a product cluster based at least in part on product metadata;
correlating the product cluster based at least in part on product correlation data; and
calculating each product distance to a center of each correlated product cluster.

2. The method of claim 1 wherein the product metadata comprises data from one or more book publishers and/or online book sellers, including at least one of book genre-based taxonomy, demographics of user, and/or previous purchase information associated with that user.

3. The method of claim 2 wherein the product metadata further comprises time of year.

4. The method of claim 1 wherein the product correlation data comprises product co-purchase correlation data that reflects related products previously purchased or considered by a given user.

5. The method of claim 1 wherein the product correlation data comprises product correlation data that reflects related products contemporaneously considered by a given user within a single transaction.

6. The method of claim 1 wherein forming the product cluster is initiated in response to a user request.

7. The method of claim 1 further comprising:
displaying recommendations to a given user based on product clusters, wherein only products within a given distance to a center of each correlated product cluster are displayed.

8. The method of claim 1 further comprising:
generating recommendations based on product clusters, wherein only products within a given distance to a center of each correlated product cluster are recommended.

9. The method of claim 1 wherein forming a product cluster is carried out using k-means clustering so as to minimize the within-cluster sum of squares, the method further comprising optimizing the within cluster sum of squares.

10. The method of claim 1 further comprising:
generating an output based on product clusters, the output including related taxonomy and product recommendations.

11. The method of claim 1 wherein forming a product cluster is further based on a set of products.

12. A computer readable medium encoded with instructions that when executed by one or more processors cause a process for generating content recommendations to be carried out, the process comprising:
forming a product cluster based at least in part on product metadata;
correlating the product cluster based at least in part on product correlation data; and
calculating each product distance to a center of each correlated product cluster.

13. The computer readable medium of claim 12 wherein the product metadata comprises data from one or more book publishers and/or online book sellers, including at least one of book genre-based taxonomy, demographics of user, previous purchase information associated with that user, and/or time of year.

14. The computer readable medium of claim 12 wherein the product correlation data comprises at least one of product co-purchase correlation data that reflects related products previously purchased or considered by a given user and/or product correlation data that reflects related products contemporaneously considered by a given user within a single transaction.

15. The computer readable medium of claim 12 wherein forming the product cluster is initiated in response to a user request.

16. The computer readable medium of claim 12, the process further comprising:
displaying recommendations to a given user based on product clusters, wherein only products within a given distance to a center of each correlated product cluster are displayed.

17. The computer readable medium of claim 12, the process further comprising:
generating recommendations based on product clusters, wherein only products within a given distance to a center of each correlated product cluster are recommended.

18. The computer readable medium of claim 12 wherein forming a product cluster is carried out using k-means clustering so as to minimize the within-cluster sum of squares, the process further comprising optimizing the within cluster sum of squares.

19. The computer readable medium of claim 12, the process further comprising:
generating an output based on product clusters, the output including related taxonomy and product recommendations.

20. A computer readable medium encoded with instructions that when executed by one or more processors cause a process for generating content recommendations to be carried out, the process comprising:
forming a product cluster based at least in part on a set of products and product metadata, wherein the product metadata comprises data from one or more book publishers and/or online book sellers, including at least one of book genre-based taxonomy, demographics of user, previous purchase information associated with that user, and/or time of year;
correlating the product cluster based at least in part on product correlation data, wherein the product correlation data comprises product co-purchase correlation data that reflects related products previously purchased or considered by a given user;
calculating each product distance to a center of each correlated product cluster; and
generating recommendations based on product clusters, wherein only products within a given distance to a center of each correlated product cluster are recommended.
